(19) United States
(12) Patent Application Publication
(10) Pub. No.: US 2007/0234611 A1
(43) Pub. Date: Oct. 11, 2007

(54) Multi-laminate three-dimensional video display and methods therefore

(76) Inventor: Steven Ochs, Portland, OR (US)

Correspondence Address: CONNOLLY BOVE LODGE & HUTZ LLP, 1875 EYE STREET, N.W., SUITE 1100, WASHINGTON, DC, 20036, US

(21) Appl. No.: 11/375,335

(22) Filed: Mar. 15, 2006

(51) Int. Cl. G09F 13/04

(52) U.S. Cl. 40/577

(57) ABSTRACT

The present invention relates generally to devices and methods for the display of artwork, and particularly, but not by way of limitation, to a method for giving a video image an apparent three-dimensional character by causing an observer to view a series of color decompositions of the intended video image.

### FIELD OF THE INVENTION

The present invention relates generally to devices and methods for the display of artwork, and particularly, but not by way of limitation, to a method for giving a video image an apparent three-dimensional character by causing an observer to view a series of color decompositions of the intended video image.

### BACKGROUND

The information provided below is not admitted to be prior art to the present invention, but is provided solely to assist the understanding of the reader.

The field of fine arts constantly strives to achieve novel and unexpected images and artistic effects. The fields of advertising and artisan graphics also seek new means of rendering visually-striking images. One such approach is embodied in U.S. Pat. No. 5,367,801, to Ahn, which provides a multi-layer, three-dimensional display. Ahn synthesizes an image from three, spaced-apart transparent panels each painted with a portion of the entire image. A front panel is painted with foreground details; a back panel is painted with background details; and a middle panel is provided having other indecia adhered thereto. The overall effect is to render a scene having the appearance of depth.

Ahn renders a three-dimensional scene. However, the various images that comprise the scene appear mono-dimensional. Moreover, Ahn renders a still image. Application Ser. No. 10/901,044, to Ochs, the inventor of the present invention, provides a still, three-dimensional image by means of color decompositions. There remains a need for a fine-arts display device that renders a video image having a three-dimensional appearance.

### SUMMARY OF INVENTION

An aspect of the present invention provides a multi-layered video display providing a video image three-dimensional in appearance comprising a plurality of substantially transparent single-color layers. According to an aspect, each color layer comprises an array of video pixels. According to an aspect, each pixel of a given layer emits substantially the same color light. According to an aspect, each pixel of a given color layer emits light of the same color, which color is a color of a color model. According to an aspect, each color of the color model is emitted by at least one color layer.

According to an aspect, each array of pixels is activated is raster fashion so as to produce a video image in a single process color. According to an aspect, a plurality of single process color video images are disposed substantially in register in a mutually spaced and substantially parallel relation.

According to an aspect, a pixel may comprise an organic light emitting diode (OLED), a cathode ray tube (CRT), a liquid crystal display (LCD), light valve technology (LVT), plasma display, digital light processor (DLP), or liquid crystal on silicon (LCOS).

An aspect of the present invention provides a multi-layered display wherein each decomposed video image is rendered in a process color of a color model. In a preferred aspect, the color model is the RGB color model. In an alternative aspect, the color model is the CMYK color model. In a related aspect, at least one process color is rendered by a plurality of sub-colors. In yet a further aspect, at least one colored image, whether in a process color or a sub-color, is rendered as a halftone.

An aspect of the present invention provides each single-color layer is spaced apart by a substantially transparent spacer layer. The spacer layer may be a material such as glass or a plastic such as Plexiglas. The spacer layer may be a gas such as air.

An aspect of the present invention provides the various single-color layers and the various separation layers are substantially planar. Moreover, the various planes are mutually substantially parallel.

An aspect of the present invention provides a facial layer of a substantially transparent substance is disposed between the image layers and the position of an observer.

Still other objects and advantages of the present invention will become readily apparent by those skilled in the art from the following detailed description, wherein it is shown and described preferred embodiments of the invention, simply by way of illustration of the best mode contemplated of carrying out the invention. As will be realized the invention is capable of other and different embodiments, and its several details are capable of modifications in various obvious respects, without departing from the invention. Accordingly, the description is to be regarded as illustrative in nature and not as restrictive.

### BRIEF DESCRIPTION OF DRAWINGS

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following FIGURES:

FIG. 1 depicts a side elevation of the inventive artwork display;

It is to be noted, however, that the appended drawings illustrate only typical embodiments of this invention and are therefore not to be considered limiting of its scope, for the invention may admit to other equally effective embodiments.

### DETAILED DESCRIPTION OF A PREFERRED EMBODIMENT

Reference is made to the FIGURES to illustrate selected embodiments and preferred modes of carrying out the invention. It is to be understood that the invention is not hereby limited to those aspects depicted in the FIGURES.

To print a full-color photo, or a graphic, with an offset printing press, one must first separate, or decompose, the photo into the four basic ink colors: cyan, magenta, yellow, and black (CMYK). Each color is then printed separately, as a single-color layer, one on top of the other, to give the impression of infinite colors. An aspect of the present invention arranges that an observer view a succession of single-color layers, mounted on transparent substrates, such that a full-color, three dimensional image is observed.

Process color separation is a method of mixing three or four colors to produce any of an infinite variety of colors. The three or four basic colors are known as “process colors.” CMYK is a color model in which all colors are described as a mixture of four process colors, cyan, magenta, yellow, and black. CMYK is the standard color model used in offset printing for full-color documents. Because such printing uses inks of these four basic colors, it is often called four-color printing.

Video display devices generally use a different color model called RGB, comprised of process colors, red, green, and blue. The RGB color model is a preferred, but non-limiting, color model for purposes of the present invention.

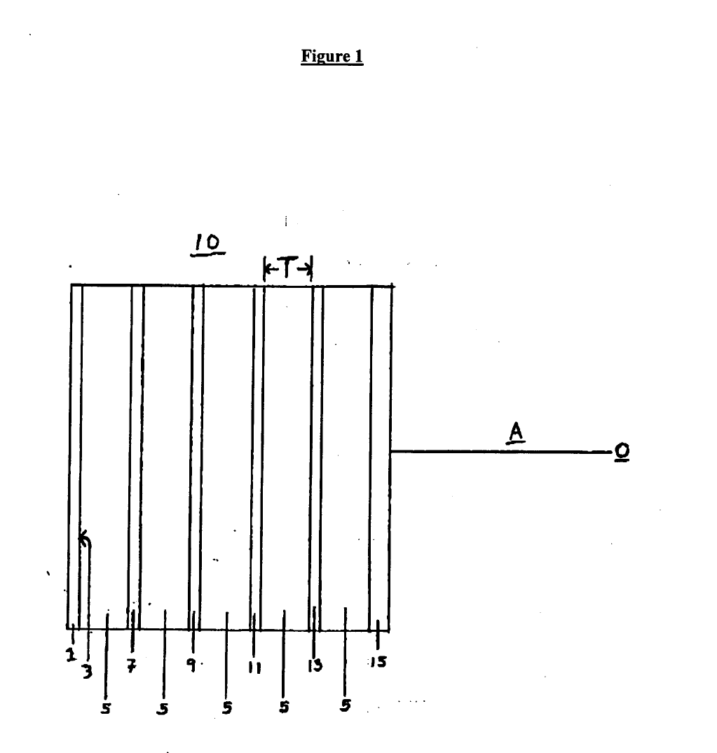

A side elevation of the inventive display is presented in FIG. 1. Display 10 comprises a plurality of substantially planar, parallel members 5, 7, 9, 11, and 13. Display 10 may optionally comprise substantially planar, parallel members 1 and 15.

Optional member 1 is a backing member, made of an opaque material such as wood or metal. Display 10 positioned such that an observer O, views member 1 through members 5, 7, 9, 11, 13, and optionally 15. Preferably, member 1 is coated with a reflective material. Preferably, the reflective material is colored white. Optional frontal member 15 is a substantially-transparent protective member.

Members 7, 9, 11, and 13 are single color layers. Members 5 are spacer layers. The spacer layers are made of a substance substantially-transparent to visible light. Substantially-transparent is defined in terms of the percentage of incident light that is transmitted through the layer. In an embodiment, at least 80% of visible light incident on spacer 5, in a direction parallel to the line of sight of observer O, is transmitted therethrough. In preferred embodiments, preferably at least 90% of the incident light is transmitted; more preferably at least 92%; more preferably at least 94%; more preferably at least 96%; more preferably at least 98% is transmitted. Spacer 5 may be an evacuated space, or a gas, such as air. Alternatively, spacer 5 may comprise a rigid material, such as glass or plastic, so long as it is substantially-transparent. Spacer 5 has a thickness T parallel to the line of sight of an observer O. Thickness T may be any thickness that enhances a visual effect of observing the image in the display.

Members 7, 9, 11, and 13 are single color layers. The number of color layers is controlled by the color model used in the specific embodiment. Preferably, there is at least one color layer for each process color in the color model. In some embodiments, a process color may be rendered by a plurality of sub-colors. Preferable, each sub-color is rendered on a unique color layer. The invention admits of additional color layers beyond those indicated in FIG. 1.

An image to be displayed is decomposed into an appropriate number of process colors and or sub-colors. Each decomposed image is rendered on a unique single color layer. Layers 7, 9, 11, and 13 are made of a substantially-transparent material. Layers 7, 9, 11, and 13 may be made from a mechanically rigid material such as glass or plastic. Alternatively, layers 7, 9, 11, and 13 may comprise a thin, mechanically compliant film. Where layers 7, 9, 11, and 13 comprise a thin film, the film may be mechanically supported by frame wherein the frame is disposed away from a viewing area. Alternatively, the film may be adhered to a face, a major surface, of a spacer member. In an embodiment, layers 7, 9, 11, and 13 may be rendered as a layer of ink, or other coloring matter, applied directly to a major surface of a spacer member. The coloring matter of a single color layer may be applied as an array of dots or pixels, such as a halftone image.

In a preferred embodiment, the various single color layer images are substantially in register. As used herein, the term “in register” means that the images are disposed such that an observer in position O (FIG. 1) appears to see substantially a single image. In other embodiments, the various images may be out of register.

In a preferred embodiment, a single color layer is rendered as a substantially planar image. In a preferred embodiment, the planes of the various images are substantially parallel. In an alternative embodiment, an image is rendered on the surface of a sphere or a sphereoid. When an image is rendered on the surface of a spheroid, it is preferred that the various spheroidal surfaces be substantially concentric.

In an embodiment, any or all of the spacer members and/or the single color layer members may be supported by a frame. Where a frame is used, it is preferred that the frame be disposed away from a viewing area.

Each color layer may be a video display terminal (VDT). Each VDT of the present invention may display a single process color, or sub-color, of a color model. Each color layer is made as an array of multiple pixel elements. Preferably, each pixel element is independently operable. Preferably, each pixel element is independently addressable.

Preferably, color layers 7, 9, 11, and 13 are made of a substance substantially-transparent to visible light. Substantially-transparent is defined in terms of the percentage of incident light that is transmitted through the layer. In an embodiment, at least 80% of visible light incident on layer 7, 9, 11, and 13, in a direction parallel to the line of sight of observer O, is transmitted therethrough. In preferred embodiments, preferably at least 90% of the incident light is transmitted; more preferably at least 92%; more preferably at least 94%; more preferably at least 96%; more preferably at least 98% is transmitted.

According to an aspect, a pixel may comprise an organic light emitting diode (OLED), a cathode ray tube (CRT), a liquid crystal display (LCD), light valve technology (LVT), plasma display, digital light processor (DLP), or liquid crystal on silicon (LCOS).

In a preferred embodiment, each pixel is an OLED. Illustrative, non-limiting OLED are disclosed by Kwong (U.S. Pat. No. 6,982,179), the entire contents of which is incorporated by reference.

The pixels are controlled by electronic means. Persons of skill in the video display arts are familiar with various electronic means to control pixel elements.

Although the illustrative embodiments of the invention are drawn from the fine, visual arts, the invention is not intrinsically limited to that art.

Furthermore, it is to be understood that the form of the invention shown and described is to be taken as presently preferred embodiments. Various modifications and changes may be made to each and every processing step as would be obvious to a person skilled in the art having the benefit of this disclosure. It is intended that the following claims be interpreted to embrace all such modifications and changes and, accordingly, the specification and drawings are to be regarded in an illustrative rather than a restrictive sense. Moreover, it is intended that the appended claims be construed to include alternative embodiments.

### INCORPORATION BY REFERENCE

All publications and patent applications cited in this specification are herein incorporated by reference, and for any and all purposes, as if each individual publication or patent application were specifically and individually indicated to be incorporated by reference. Specifically, Pre-Grant Patent Publication US 2006/0021268, by the inventor of the present invention, is specifically incorporated in its entirety by reference. In the case of inconsistencies the present disclosure will prevail.

Having thus described our invention, what we claim as new, and desire to secure by Letters Patent is:

1. A multi-layered display providing a video image substantially three-dimensional in appearance comprising:
a plurality of process color layers, each said layer comprising a plurality of individually-addressable, monochromatic pixels;
at least one spacer layer disposed between each said color layer; and
digital address means to operate each said pixel.

2. The multi-layered display, according to claim 1, wherein each said color layer displays a decomposed image in a single process color of a color model.

3. The multi-layered display, according to claim 2, wherein each process color of said color model is displayed on at least one of said process color layers.

4. The multi-layered display, according to claim 1, wherein each said pixel has a substantially transparent off-state.

5. The multi-layered display, according to claim 1, wherein each said pixel is selected from the group consisting of organic light emitting diodes, cathode ray tubes, liquid crystal displays, light valves, plasma displays, digital light processors, and liquid crystal on silicon processors.

6. The multi-layered display, according to claim 5, wherein each said pixel is an organic light emitting diode.

7. The multi-layered display, according to claim 1, wherein each said layer is substantially in register.

8. The multi-layered display, according to claim 1, wherein said color layer comprises said spacer layer.

9. The multi-layered display, according to claim 1, further comprising a frontal layer of a substantially transparent substance.

10. The multi-layered display, according to claim 2, wherein said color model is the RGB color model.

11. The multi-layered display, according to claim 2, wherein said color model is the CMYK color model.

12. The multi-layered display, according to claim 2, wherein at least one decomposed image is a halftone image.

13. The multi-layered display, according to claim 2, wherein
at least one process color is decomposed into a plurality of sub-colors, and wherein
each process color and sub-color is emitted from a unique single-color layer.

14. The multi-layered display, according to claim 1, further comprising a backing layer.

15. The multi-layered display, according to claim 13, wherein said backing layer comprises a white, reflective coating.

16. The multi-layered display, according to claim 1, wherein each said spacer layer is substantially transparent.

17. The multi-layered display, according to claim 15, wherein said spacer layer transmits at least 80% of the visible light incident thereon.

18. The multi-layered display, according to claim 1, wherein said image is substantially planar.

19. The multi-layered display, according to claim 1, wherein said image is rendered on at least a portion of a spheroid.
